(19) United States
(12) Patent Application Publication
(10) Pub. No.: US 2016/0333234 A1
(43) Pub. Date: Nov. 17, 2016

(54) LAMINATE AND POLARIZING PLATE

(71) Applicant: ZEON CORPORATION, Tokyo (JP)

(72) Inventor: Manabu TSUBURAYA, Tokyo (JP)

(73) Assignee: ZEON CORPORATION, Tokyo (JP)

(21) Appl. No.: 15/112,929

(22) PCT Filed: Jan. 28, 2015
(86) PCT No.: PCT/JP2015/052401

§ 371 Date: Jul. 20, 2016

(30) Foreign Application Priority Data
Jan. 30, 2014 (JP) 2014-016161

(51) Int. Cl. C09J 135/02; B32B 27/06; B32B 7/12; G02B 5/30; G02F 1/1335

(52) U.S. Cl. CPC C09J 135/02; G02B 5/305; G02F 1/133528; B32B 7/12; B32B 27/06; C09J 2421/006; C09J 2203/318; B32B 2307/42

(57) ABSTRACT

A layered body including an optical film A containing an alicyclic structure-containing polymer and an adhesive layer B, therein a critical stress change ratio thereof calculated by the following formula 1 is 40% or less:

$$( critical stress change ratio ) = \frac{( \begin{matrix}critical stress of optical film A - \\ critical stress of layered body\end{matrix} )}{critical stress of optical film A} \times 100 \qquad ( Formula 1 )$$

### FIELD

The present invention relates to a layered body having an optical film A including an alicyclic structure-containing polymer and an adhesive layer B, and a polarizing plate including the layered body. In the following description, the layered body having the optical film A and the adhesive layer B may be referred to as a “layered body C”.

### BACKGROUND

An optical film including an alicyclic structure-containing polymer is excellent in visibility as well as durability in a humid heat environment, and thus, often used as a protective film for polarizer (Patent Literature 1).

### CITATION LIST

### Patent Literature

Patent Literature 1: Japanese Patent No. 4461735B

### SUMMARY

### Technical Problem

When an optical film including an alicyclic structure-containing polymer and a polarizer are layered to form a polarizing plate, an adhesive may sometimes be used. Further, when the polarizer is bonded to a liquid crystal display panel or a cover glass for liquid crystal display device, an adhesive may sometimes be used. However, using such an adhesive sometimes caused a crack in the optical film including an alicyclic structure-containing polymer. When the crack occurs as described, visibility of an image displayed on the liquid crystal display device may sometimes be reduced. The present invention is made in view of the above-mentioned problem and an object of the present invention is to provide a layered body having an optical film including an alicyclic structure-containing polymer and an adhesive layer, wherein the layered body does not cause a crack or the like even when an optical member is produced by bonding the optical film including an alicyclic structure-containing polymer to another layer through the adhesive layer.

### Solution to Problem

The present inventor has conducted intensive studies and has found out that the above-mentioned problem can be solved by forming a layered body using a specific adhesive.

That is, the present invention is as follows.
(1) A layered body comprising an optical film A including an alicyclic structure-containing polymer and an adhesive layer B, wherein

a critical stress change ratio thereof calculated by

the following formula 1 is 40% or lass:

$$( critical stress change ratio ) = \frac{( \begin{matrix}critical stress of optical film A - \\ critical stress of layered body\end{matrix} )}{critical stress of optical film A} \times 100 \qquad ( Formula 1 )$$

(2) The layered body according to (1), wherein the adhesive layer B contains an ultraviolet-curable resin.
(3) The layered body according to (1) or (2), wherein the adhesive layer B contains a urethane acrylate.
(4) The layered body according to any one of (1) to (3), wherein an amount of a material having a high compatibility with the alicyclic structure-containing polymer in the adhesive layer B is 25% by weight or less.
(5) A polarizing plate comprising the layered body according to any one of (1) to (4) and a polarizer.

### Advantageous Effects of Invention

According to the present invention, a layered body which does not cause a crack or the like and hardly reduces visibility when an optical film including an alicyclic structure-containing polymer is used as a protective film for polarizing plate can be obtained.

### BRIEF DESCRIPTION OF DRAWINGS

FIG. 1 is a cross-sectional view schematically illustrating a one-quarter elliptic jig having a curve expressed by x²/100²+y²/40²=1, used for measuring critical stress.

FIG. 2 is a schematic view illustrating one example of a polarizing plate of the present invention.

FIG. 3 is a cross-sectional view schematically illustrating an example of a configuration in which a layered body of the present invention is applied to a liquid crystal display device.

### DESCRIPTION OF EMBODIMENTS

Hereinafter, the present invention will be described in detail. The present invention may be optionally modified for implementation within the scope not departing from the claims of the present invention and equivalents thereto.

In the following description, a “polarizing plate” and a “quarter-wave plate” include not only a rigid plate but also a flexible film such as a resin film unless otherwise specified.

### Optical Film A

The optical film A of the present invention is a film including an alicyclic structure-containing polymer. The alicyclic structure-containing polymer refers to a polymer that has an alicyclic structure in either or both of a main chain and a side chain. Of these, a polymer including an alicyclic structure in a main chain is preferable from the viewpoint of mechanical strength, heat resistance, and the like. Examples of the alicyclic structure may include a saturated cyclic hydrocarbon (cycloalkane) structure and an unsaturated cyclic hydrocarbon (cycloalkene and cycloalkyne) structure. Of these, the cycloalkane structure and the cycloalkene structure are preferable and the cycloalkane structure is particularly preferable, from the viewpoint of mechanical strength, heat resistance, and the like.

The number of carbon atoms constituting the alicyclic structure is preferably 4 or more, more preferably 5 or more, and is preferably 30 or less, more preferably 20 or less, and particularly preferably 15 or less, per alicyclic structure. When the number of carbon atoms constituting the alicyclic structure is within the above-mentioned range, the alicyclic structure exhibits mechanical strength, heat resistance, and formability in a highly balanced manner and is thus preferable.

The ratio of repeating units having the alicyclic structure in the alicyclic structure-containing polymer may be suitably selected in accordance with the use of the optical film A, but it is usually 50% by weight or more, preferably 70% by weight or more, and more preferably 90% by weight or more. When the ratio of the repeating units having the alicyclic structure is too small, heat resistance may be reduced. Repeating units other than the ones having the alicyclic structure in the alicyclic structure-containing polymer may be suitably selected in accordance with the purpose of use of the optical film A.

Specific examples of the alicyclic structure-containing polymer may include: (1) a norbornene-based polymer; (2) a cyclic olefin polymer having a monocyclic structure and a hydrogenated product thereof; (3) a cyclic conjugated diene polymer and a hydrogenated product thereof; and (4) a vinyl alicyclic hydrocarbon-based polymer. Examples of the above-mentioned (1) norbornene-based polymer may include: a ring-opened polymer of a norbornene-based monomer, a ring-opened copolymer of a norbornene-based monomer and an optional monomer that is capable of undergoing a ring-opening copolymerization therewith, and hydrogenated products thereof; and an addition polymer of a norbornene-based monomer and an addition copolymer of a norbornene-based monomer and an optional monomer that is copolymerizable therewith. The norbornene-based monomer described herein refers to a monomer having a norbornene ring structure. Further, examples of the above-mentioned (4) vinyl alicyclic hydrocarbon-based polymer may include: a polymer of a vinyl alicyclic hydrocarbon monomer, a copolymer of a vinyl alicyclic hydrocarbon monomer and an optional monomer that is copolymerizable therewith, and hydrogenated products thereof; and a hydrogenated product of a polymer of a vinyl aromatic monomer in which an aromatic ring is hydrogenated and a hydrogenated product of a copolymer of a vinyl aromatic monomer and an optional monomer that is copolymerizable therewith, in which an aromatic ring is hydrogenated. Of these, from the viewpoint of heat resistance, mechanical strength, and the like, the norbornene-based polymer and the vinyl alicyclic hydrocarbon-based polymer are preferable, and the hydrogenated product of the ring-opened polymer of a norbornene-based monomer, the hydrogenated product of the ring-opened copolymer of a norbornene-based monomer and an optional monomer that is ring-opening copolymerizable therewith, the hydrogenated product of a polymer of a vinyl aromatic-based monomer in which an aromatic ring is hydrogenated, and the hydrogenated product of a copolymer of a vinyl aromatic monomer and an optional monomer that is copolymorizable therewith, in which an aromatic ring is hydrogenated, are further preferable.

As the alicylic structure-containing polymer, one type thereof may be solely used, and two or more types thereof may also be used, in combination at any ratio.

The ratio of the alicyclic structure-containing polymer in the optical film A is preferably by weight to 100% by weight, and more preferably 77% by weight to 100% by weight.

Further, the optical film A may include an optional component other than the alicyclic structure-containing polymer as long as the effects of the present invention are not seriously impaired. Examples of the optional component other than the alicyclic structure-containing polymer may include publicly known additives, such as an antioxidant, a heat stabilizer, a light stabilizer, an ultraviolet absorbing agent, an antistatic agent, a dispersant, a chlorine-capturing agent, a flame retardant, a nucleating agent for crystallization, a reinforcing agent, an anti-blocking agent, an anti-fogging agent, a release agent, a pigment, an organic or inorganic filler, a neutralizer, a lubricant, a decomposing agent, a metal-inactivating agent, a contamination inhibitor, an antibacterial agent, as well as a polymer other than the alicyclic structure-containing polymer, and a thermoplastic elastomer. One type thereof may be solely used, and two or more types thereof may also be used in combination at any ratio. However, the amount of the optional component other than the alicyclic structure-containing polymer included in the optical film A is in such a range as not to impair the effects of the present indention, and is usually 50 parte by weight or less, preferably 30 parts by weight or less, relative to 100 parts by weight of the alicyclic structure-containing polymer. The lower limit is zero.

Further, the optical film A may be a film of a single-layer structure having only one layer, and may also be a film of a multilayer structure having two or more layers. When the optical film A is a film of a single-layer structure, this layer may include the alicyclic structure-containing polymer. Further, when the optical film A is a film of a multilayer structure, a layer that is farthest from the adhesive layer B preferably includes the alicyclic structure-containing polymer. A masking film may sometimes be attached to a surface of the optical film A that is farthest from the adhesive layer B. In this case, when the layer of the optical film A that is farthest from the adhesive layer B includes the alicyclic structure-containing polymer, the masking film can be easily peeled off.

The optical film A preferably has a function of absorbing ultraviolet rays for the reason of preventing the deterioration of a polarizer and a liquid crystal element caused by exterior light. In order to impart the function of absorbing ultraviolet rays to the optical film A, the ultraviolet-absorbing agent may be included in the optical film A of a single-layer structure. Further, for the reason of preventing a roll and a film from being contaminated during processes, the ultraviolet absorbing agent is preferably included in an intermediate layer of the optical film A of a multilayer structure. The intermediate layer of the optical film A of the multilayer structure described herein refers to a layer that is not exposed to the outside as a front or a back surface of the optical film A among a plurality of layers included in the optical film A. For example, when the optical film A includes three or more layers, the intermediate layer is a layer other than the layer nearest to the adhesive layer B and the layer farthest from the adhesive layer B.

The light transmittance of the optical film A having the function of absorbing ultraviolet rays at a wavelength of 380 nm is preferably 0.02% to 8.0%, and more preferably 0.05% to 5.0%, Further, the light transmittance of the optical film A having the function of absorbing ultraviolet rays at a wavelength of 370 nm is preferably 2% or less, and more preferably 1% or less. Further, the light transmittance of the optical film A having the function of absorbing ultraviolet rays at a wavelength of 400 nm is preferably 65% or more. Further, the light transmittance of the optical film A having the function of absorbing ultraviolet rays at a wavelength of 420 nm to 780 nm is preferably 85% or more, and more preferably 88% or more. If the light transmittance at a wavelength of 380 nm is less than 0.05%, the entire layered body C may become quite yellowish in color. Thus, when such a layered body C is mounted on a display device such as a liquid crystal display device, the device may become colored especially when used for a long period of time. Conversely, if the light transmittance at a wavelength of 380 nm exceeds 8.0%, a degree of polarization may be reduced by a change in a polarizer caused by ultraviolet rays. If the light transmittance at a wavelength of 420 nm to 780 nm is less than 85%, when such a layered body C is mounted on a display device such as a liquid crystal display device, brightness of the device may be reduced especially when used for a long period of time.

For imparting the function of absorbing ultraviolet rays to the optical film A, the optical film A may contain the ultraviolet absorbing agent. As the ultraviolet absorbing agent, for example, the ones that are publicly known, such as a benzophenone-based ultraviolet absorbing agent, a benzotriazole-based ultraviolet absorbing agent, and an acrylonitrile-based ultraviolet absorbing agent, may be used. Examples of the ultraviolet absorbing agent that are preferably used may include 2,2′-methylenebis(4-(1,1,3,3-tetramethylbutyl)-6-(2H-benzotriazol-2-yl)phenol), 2-(2′-hydroxy-3′-tert-butyl-5′-methylphenyl)-5-chlorobenzotriazole, 2,4-di-tert-butyl-6-(5-chlorobenzotriazole-2-yl)phenol, 2,2′-dihydroxy-4,4′-dimethoxybenzophenone, and 2,2′,4,440 -tetrahydroxybenzophenone. Of these, 2,2′-methylenebis(4-(1,1,3,3-tetramethylbutyl)-6-(2H-benzotriazol-2-yl)phenol) is particularly preferable.

Examples of the method for obtaining the optical film A containing the ultraviolet absorbing agent may include: a method in which the ultraviolet absorbing agent is blended in a resin of the alicyclic structure-containing polymer in advance; a method in which a master batch containing the ultraviolet absorbing agent at a high concentration is used; and a method in which the ultraviolet absorbing agent is directly supplied to a resin when the resin is subjected to melt extrusion molding. Any of these methods may be employed. When the optical film A of a multilayer structure containing the ultraviolet absorbing agent is obtained, it is preferable that the ultraviolet absorbing agent is included in an intermediate layer in order to suppress the contamination of the ultraviolet absorbing agent during manufacturing processes. The content of the ultraviolet absorbing agent is preferably 0.5% by weight to 7.0% by weight, and more preferably 1.0% by weight to 5.0% by weight, relative to the total of the optical film A being 100% by weight. It is preferable that fluctuation in the concentration of the ultraviolet absorbing agent is within ±0.1% in the entire surface. By the content of the ultraviolet absorbing agent being between 0.5% by weight to 7.0% by weight, ultraviolet rays can be efficiently blocked without worsening color tones of a polarizing plate and a reduction in a degree of polarization can be presented after use for a long period of time. If the content of the ultraviolet absorbing agent is less than 0.5% by weight, the light transmittances at wavelengths of 370 nm and 380 nm may be increased, and use of such a layered body C as a masking film of a polarizing plate may cause reduction in a degree of polarization of a polarizer. Conversely, if the content of the ultraviolet absorbing agent exceeds 7.0% by weight, the light transmittance in a short wavelength side may be reduced, and thus such a layered body C may become more yellowish in color. The content of the ultraviolet absorbing agent may be appropriately changed depending on the thickness of the optical film A. When the fluctuation in the concentration of the ultraviolet absorbing agent is within ±0.1% by weight in the entire surface, unevenness of color tones in the optical film A at an early stage is eliminated, and deterioration due to ultraviolet rays after use for a long period of time causes in a uniform manner. Thus unevenness of color tones hardly occurs when such a layered body C is mounted on a liquid crystal display device. If the fluctuation in the concentration of the ultraviolet absorbing agent exceeds ±0.1% by weight in the entire surface, unevenness of color tones may be clearly visually recognized, thus causing a defect in color tones. Further, after use for a long period of time, deterioration due to ultraviolet rays may become uneven, further worsening the defect in color tones.

The thickness of the optical film A is preferably 5.0 μm or more and 1000 μm or less, more preferably 10 μm or more and 500 μm or less, and particularly preferably 10 μm or more and 100 μm or less. Also when the optical film A has a multilayer structure, the total thickness of the film is preferably within the above-mentioned range. When the optical film A has a multilayer structure, a thickness of each layer may be adjusted in conformity with an intended use and the like. When the optical film A includes, for example, the intermediate layer containing the ultraviolet adsorbing agent as mentioned above, the thickness of the intermediate layer is preferably 2.0 μm or more and 500 μm or less, more preferably 5.0 μm or more and 50 μm or less, and particularly preferably 5.0 μm or more and 40 μm or less.

The optical film A used in the present invention may be obtained by molding a resin including an alicyclic structure-containing polymer and an optional component, if necessary, into a film shape by a publicly known method. Examples of the above-mentioned method may include a cast molding method, an extrusion molding method, an inflation molding method, and stretching. Of these, the extrusion molding method is preferable since it leaves a less quantity of residual volatile component(s) and has excellent size stability. The content of the residual volatile component(s) in the optical film A is preferably 0.1% by weight or less, more preferably 0.05% by weight, or less, and further preferably 0.02% by weight or less. If the content of the residual volatile component(s) is high, there is concern that optical characteristics of the layered body C may change over time.

The optical film A may have a single-layer structure as mentioned above, and may also have a multilayer structure of two or more layers. In the case of having the multilayer structure, the optical film A may be obtained by a publicly known method such as a co-extrusion molding method, a film lamination method, and an application method, however the co-extrusion molding method is preferable. Fluctuation in a film thickness of the optical film A is preferably 5% or less, and more preferably 4% or less, relative to an average thickness. The fluctuation in the film thickness described herein refers to a value obtained by subtracting the minimum value from the maximum value among values measured at equal intervals in a width direction of the optical film A. The average thickness is an average value of values measured at equal intervals in a width direction of the optical film A.

When the optical film A is obtained by stretching a non-stretched film, the film subjected to a publicly known stretching treatment such as uniaxial stretching, biaxial stretching, or diagonal stretching may appropriately be adopted. Examples of the stretching method may include, but is not particularly limited to: a roll-type and floating-type longitudinal stretching methods; a tenter-type crosswise uniaxial stretching; and a simultaneous biaxial stretching. The stretching temperature of the non-stretched film is within a temperature range of, preferably Tg−30° C. to Tg+60° C., and more preferably Tg−10° C. to Tg+50° C. The Tg described herein refers to a glass transition temperature of the above-mentioned resin including an alicyclic structure-containing polymer. Further, the stretch ratio is usually 1.01 times to 30 times, preferably 1.01 times to 10 times, and more preferably 1.01 times to 5 times.

When the optical film A is a stretched film, such an optical film A is preferably a film having characteristics of a quarter-wave plate. The film having characteristics of a quarter-wave plate described herein refers to a film having an in-plane retardation value (Re) of 80 nm to 160 nm and a retardation value in a film thickness direction (Rth) in a range of −250 nm to +150 nm, with respect to transmitted light that is visible light at a wavelength of 550 nm.

The in-plane retardation (Re) is a value obtained by multiplying the difference between a refractive index nx in an in-plane slow axis direction and a refractive index ny in a direction orthogonal to the slow axis in the same plane by an average film thickness d (Re=(nx−ny)×d). Further, the retardation (Rth) in a film thickness direction is expressed by Rth=((nx+ny)/2−nz)×d. in those formulae: nx denotes a refractive index in an in-plane slow axis direction; ny denotes a refractive index in a direction orthogonal to the slow axis in the same plane; nz denotes a refractive index in a thickness direction; and d denotes an average film thickness.

The in-plane retardation value (Re) of the optical film A is preferably 80 nm to 160 nm, and further preferably 90 nm to 150 nm.

In the present invention, fluctuation in the in-plane retardation (Re) of the optical film A is preferably 10 nm or less, more preferably 5 nm or less, and particularly preferably 2 nm or less. By keeping the fluctuation in the in-plane retardation Re of the optical film A the above-mentioned range, when such a layered body C is used as a phase difference film for a liquid crystal display device, display quality thereof can be made favorable.

The retardation value in the film thickness direction (Rth) of the optical film A is preferably −250 nm to +150 nm, more preferably −80 nm to +150 nm, and further preferably 40 nm to 150 nm. Fluctuation in the retardation value in the film thickness direction (Rth) of the optical film A is preferably 10 nm or less, more preferably 5 nm or less, and particularly preferably 2 nm or less.

### Adhesive Layer B

The adhesive layer B may be formed by applying an adhesive onto the optical film A including the alicyclic structure-containing polymer. Alternatively, the adhesive layer B may be formed by laminating a sheet-shaped adhesive layer onto the optical film A including the alicyclic structure-containing polymer. The adhesive layer described herein refers to a layer composed of an adhesive. The adhesive described above usually contains a resin as a main component. In this description, the “main component” refers to a component having a weight ratio of usually 30% by weight or more, preferably 40% by weight or more, and more preferably 50% by weight or more. As such a resin, an ultraviolet-curable resin is preferably used. When the ultraviolet-curable resin is used as the adhesive, the layered body C may be usually bonded to an optional member by irradiating with ultraviolet rays the adhesive layer B in a state that a surface of the layered body C on the adhesive layer B side is attached to the optional member, and then curing the adhesive layer B.

No particular limitation is imposed on the above-mentioned adhesive or adhesive layer so long as a critical stress change ratio calculated by the formula 1 is 40% or less when used in the layered body C, however it is preferably optically transparent. The “optically transparent” used herein means that a total light transmittance is 88% or more in terms of a thickness of 1 mm. This total light transmittance may be measured using a spectrophotometer (manufactured by JASCO Corp., ultraviolet-visible-near-infrared spectrophotometer “V-570”) in accordance with JIS K0115. Examples of the adhesive or the adhesive layer may include ethylene-based ones such as acrylic-based, urethane-based, polyester-based, polyvinyl alcohol-based, polyolefin-based, modified polyolefin-based, polyvinyl alkyl ether-based, rubber-based, ethylene-vinyl acetate-based, vinyl chloride-vinyl acetate-based, SEBS (styrene-ethylene-butylene-styrene copolymer)-based, SIS (styrene-isoprene-styrene block copolymer)-based, and ethylene-styrene copolymer, as well as acrylic ester-based ones such as ethylene-methyl (math)acrylate copolymer and ethylene-ethyl (methacrylate copolymer. Of these, in particular the urethane-based adhesive or adhesive layer is preferable and the urethane acrylate-based adhesive or adhesive layer is particularly preferable. The urethane acrylate-based adhesive described herein refers to an adhesive containing a urethane acrylate.

The urethane acrylate is not particularly limited. However, the urethane acrylate is preferably synthesized from a component such as hydroxyl group-modified hydrogenated polybutadiene, isophorone diisocyante, 2-hydroxyethyl acetate, 2-ethylhexyl acrylate, 4-acryloylmorpholine, ε-caprolactone, trimethylhexamethylene diisocyanate, and polypropyleneglycol.

Further, for the purpose of improving flowability of the adhesive, the adhesive or the adhesive layer preferably includes, for example, a (meth)acrylate-based compound, a polyfunctional (meth)acrylic compound, and an isocyanate compound. The term “(meth)acrylate” represents both acrylate and methacrylate. Further the term “(meth)acryl-” represents both acryl- and methacryl-. Examples of the (meth)acrylate-based compound may include a (meth)acrylate having one polymerizable unsaturated group per molecule, a (meth)acrylate having two polymerizable unsaturated groups per molecule, a (meth)acrylate having three or more polymerizable unsaturated groups per molecule, and a (meth)acrylate oligomer having three or more polymerizable unsaturated groups per molecule. The (meth)acrylate-based compound may be solely used, and two or more types thereof may also be used. Of these, the (meth)acrylate having one polymerizable unsaturated bond per molecule can impart flexibility and is thus preferably used.

Examples of the (meth)acrylate having one polymerizable unsaturated group per molecule may include various (meth)acrylates such as methyl (meth)acrylate, ethyl (meth)acrylate, butyl (meth)acrylate, hexyl (meth)acrylate, octyl (meth)acrylate, dodecyl (meth)acrylate, stearyl (meth)acrylate, benzyl (meth)acrylate, methoxyethyl (meth)acrylate, methoxyethoxyethyl (meth)acrylate, ethoxyethyl (meth)acrylate, ethoxyethoxyethyl (meth)acrylate, diethylene glycol mono(meth)acrylate, triethylene glycol mono(meth)acrylate, dipropylene glycol mono(meth)acrylate, phenoxyethyl (meth)acrylate, phenoxyethoxyethyl (meth)acrylate, p-tert-butylphenoxyethoxyethyl (meth)acrylate, p-nonylphenoxyethoxyethyl (meth)acrylate, octylphenoxyethioxyethyl (meth)acrylate, ethoxylated phenylphenol (meth)acrylate, ethoxylated-phenylphenol (meth)acrylate, phenoxypolyethylene glycol (meth)acrylate, 2-(meth)acryloyloxyethyl succinate, dodecylphenoxyethoxyethyl (meth)acryate isobornyl (meth)acrylate, cyclohexyl (meth)acrylate, and tetrahydrofurfuryl (meth)acrylate.

Examples of the (meth)acrylate having two polymerizable unsaturated groups per molecule may include various acrylates such as ethylene glycol di(meth)acrylate, diethylene glycol di(meth)acrylate, triethylene glycol di(meth)acrylate, polyethylene glycol di(meth)acrylate, propylene glycol di(meth)acrylate, dipropylene glycol di(meth)acrylate, tripropylene glycol di(meth)acrylate, polypropylene glycol di(meth)acrylate, butylene glycol di(meth)acrylate, pentyl glycol di(meth)acrylate, neopentyl glycol di(meth)acrylate, hydroxypivaloyl hydroxypivalate di(meth)acrylate, hydroxypivaloyl hydroxypivalate dicaprolactonate di(meth)acrylate, 1,6-hexanediol di(meth)acrylate, tricyclodecane methanol di(meth)acrylate, tricyclodecane dimethylol di(meth)acrylate, tricyclodecane dimethylol dicaprolactonate di(meth)acrylate, isocyanuric acid EO-modified di(meth)acrylate, 9,9-bis(4-(meth)acryloyloxyphenyl) fluorene, 9,9-bis(3-methyl-4-(meth)acryloyloxyphenyl) fluorene, 9,9-bis(3methyl-4-(2-(meth)acrycloyloxyethoxylphenyl) fluorene, bisphenol A tetraethylane oxide adduct di(meth)acrylate, bisphenol A polyalkylene oxide adduct di(meth)acrylate, bisphenol F tetraethylene oxide adduct di(meth)acrylate, bisphenol F polyalkylene oxide adduct di(meth)acrylate, bisphenol S tetraethylene oxide adduct di(meth)acrylate, bisphenol S polyalkylene oxide adduct di(meth)acrylate, hydrogenated bisphenol A tetraethylene oxide adduct di(meth)acrylate, hydrogenated bisphenol A polyalkylene oxide adduct di(meth)acrylate, hydrogenated bisphenol F tetraethylene oxide adduct di(meth)acrylate, hydrogenated bisphenol F polyalkylene oxide adduct di(meth)acrylate, hydrogenated bisphenol A di(meth)acrylate, hydrogenated bisphenol F di(meth)acrylate, dihydroxybenzene (catechol, resorcin, hydroquinone, etc.) polyalkylene oxide di(meth)acrylate, alkyl dihydroxybenzene polyalkylene oxide di(meth)acrylate, bisphenol A tetraethylene oxide adduct dicaprolactonate di(meth)acrylate, bisphenol F tetraethylene oxide adduct dicaprolactonate di(meth)acrylate, and 1,4-cyclohexane dimethanol di(meth)acrylate.

Examples of the (meth)acrylate having three or more polymerizable unsaturated groups per molecule may include: various (meth)acrylates such as glycerin tri(meth)acrylate, glycerin alkylene oxide tri(meth)acrylate, trimethylolpropane tri(meth)acrylate, trimethylolpropane ethoxy tri(meth)acrylate, trimethylolpropane polyalkylene oxide tri(meth)acrylate, trimethylolpropane tricaprolactonate tri(meth)acrylate, trimethylolethane tri(meth)acrylate, trimethylol ethane polyalkylene oxide tri(meth)acrylate, trimethylol hexane tri(meth)acrylate, trimethylol hexane polyalkylene oxide tri(meth)acrylate, trimethylol octane tri(meth)acrylate, trimethylol octane polyalkylene oxide tri(meth)acrylate, pentaerythritol tri(meth)acrylate, and trihydroxybenzene (pyrogallol, etc.) polyalkylene oxide adduct triacrylate; and various (meth)acrylates such as pentaerythritol tetra(meth)acrylate, pentaerythritol polyalkylene oxide tetra(meth)acrylate, pentaerythritol tetracaprolactonate tetra(meth)acrylate, diglycerin tetra(meth)acrylate, tri(meth)acrylate, diglycerin polyalkylene oxide tetra(meth)acrylate, ditrimethylolpropane tetra(meth)acrylate, ditrimethylolpropane polyalkylene oxide tetra(meth)acrylate, ditrimethylolpropane tetracaprolactonate, isocyanuric acid EO-modified tri(meth)acrylate, tetra(meth)acrylate, ditrimethylolethane tetra(meth)acrylate, ditrimethylolethane polyalkylene oxide tetra(meth)acrylate, ditrimethylolbutane tetra(meth)acrylate, ditrimethylolbutane polyalkylene oxide tetra(meth)acrylate, ditrimethylolhexane tetra(meth)acrylate, ditrimethylolhexane polyalkylene oxide tetra(meth)acrylate, ditrimethyloloctane tetra(meth)acrylate, ditrimethyloloctane polyalkylene oxide tetra(meth)acrylate, dipentaerythritol penta(meth)acrylate, dipentaerythritol hexane(meth)acrylate, dipentaerythritol polyalkylene oxide penta(meth)acrylate, dipentaerythritol hexa(meth)acrylate, dipentaerythritol polyalkylene oxide hexa(meth)acrylate, dipentaerythritol hexacaprolactonate hexa(meth)acrylate, tripentaerythritol hexa(meth)acrylate, tripentaerythritol hepta(meth)acrylate, tripentaerythritol octa(meth)acrylate, tripentaerythritol polyalkylene oxide hexa(meth)acrylate, tripentaerythritol polyalkylene oxide hepta(meth)acrylate, and tripentaerythritol polyalkylene oxide octa(meth)acrylate.

Examples of the isocyanate compound may include hexamethylene diisocyanate, 2,2,4-trimethylhexane diisocyanate, hexane diisocyanate, 1,4-cyclohexane diisocyanate, methylcyclohexylene diisocyanate, isophorone diisocyanate, dicyclohexylmethane diisocyanate, tolylene diisocyanate, 4,4!-diphenylmethane diisocyanate, xylylene diisocyanate, (meth)acryloyl isocyanate, 2-(meth)acryloyloxyethyl isocyanate, 3-(meth)acryloyloxypropyl isocyanate, 2-(meth)acryloyloxy-1-methylethyl isocyanate, 2-(meth)acryloyloxy-2-methylethyl isocyanate, 1,1-bis[(meth)acryloyloxymethyl]ethyl isocyanate, and m-(meth)acryloyloxyphenyl isocyanate.

The ratio of the urethane acrylate is preferably 10% by weight or more and 90% by weight or less, and more preferably 30% by weight or more and 80% by weight or less, relative to the total amount of the adhesive.

Specific examples of the adhesive and the adhesive layer that may be used may include SVR series (manufactured by Dexerials Corp.), TE-9000 series (manufactured by Hitachi Chemical Co., Ltd.), ThreeBond 1500 series and 1600 series (manufactured by ThreeBond Co., Ltd.), and WORLD ROCK HRJ series (Kyoritsu Chemical & Co., Ltd.).

Further, in the adhesive and the adhesive layer, the amount of a material having a high compatibility with the alicyclic structure-containing polymer is preferably 25% by weight or less. Further, it is preferable that the adhesive and the adhesive layer do not contain any material having a high compatibility with the alicyclic structure-containing polymer. Using such an adhesive or an adhesive layer makes it possible to satisfy that a critical stress change ratio calculated by the formula 1 is 40% or less,

The “material having a high compatibility with the alicyclic structure-containing polymer” described herein refers to a material that is determined to have a high compatibility by a test method described below.

### Test Method

A film having a thickness of 100 μm made of the alicyclic structure-containing polymer is prepared. A material as a sample is dripped onto this film and left for 30 minutes. After wiping the material, the film is inspected. If one or more of whitening, cracking, and deformation are observed in the film, the material as a sample is determined to have a high compatibility.

Specifically, the adhesive and the adhesive layer preferably do not contain the material having a high compatibility with the alicyclic structure-containing polymer, such as isobornyl (meth)acrylate, dicyclopentenyloxylethyl (meth)acrylate, benzyl (meth)acrylate, decyl (meth)acrylate, n-dodecyl (meth)acrylate, cyclohexane, n-octane, toluene, a terpene resin, a styrene-modified terpene resin, or dimethyl 1,4-cyclohexanedicarboxylate.

The thickness of the adhesive layer B is usually 1 μm to 400 μm and appropriately adjusted in conformity with the location of the adhesive to be used.

The forming method of the adhesive layer is not particularly limited and any publicly known application methods may be adopted. Specific examples of the application methods may include a dipping method, a spray method, a slide coating method, a bar coating method, a roll coater method, a die coater method, a gravure coater method, and a screen printing method.

### Layered Body C

The layered body C including the optical film A including the alicyclic structure-containing polymer and the adhesive layer B may be produced by applying an adhesive for forming the adhesive layer B onto a surface of the optical film A including the alicyclic structure-containing polymer. Alternatively, the layered body C may be produced by laminating the adhesive layer B onto a surface of the optical film A including the alicyclic structure-containing polymer. Prior to the application of the adhesive, the optical film A including the alicyclic structure-containing polymer may be subjected to a surface treatment. Examples of the surface treatment may include a plasma treatment, a corona treatment, an alkali treatment, and a coating treatment.

The layered body C has a critical stress change ratio calculated by the following formula 1 of 40% or less, and preferably 30% or less. In the formula 1, the term “critical stress of layered body” refers to “critical stress of layered body C”. This critical stress change ratio is usually 0% or more.

$$( critical stress change ratio ) = \frac{( \begin{matrix}critical stress of optical film A - \\ critical stress of layered body\end{matrix} )}{critical stress of optical film A} \times 100 \qquad ( Formula 1 )$$

Keeping the critical stress change ratio calculated by the formula 1 to be 40% or less can be achieved by using the adhesive made of the specific material as described above.

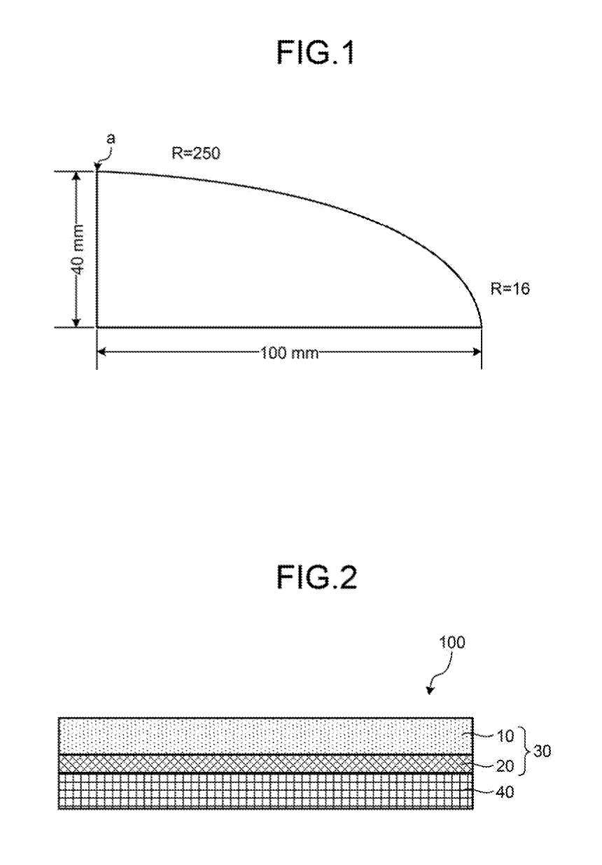

The critical stress of the optical film A is measured by fixing a test piece of the optical film A along a jig shown in FIG. 1 (cross-sectional view) and observing a state of the occurrence of a craze. The cross section of the jig shown in FIG. 1 has a shape of a quarter-cut ellipse (one-quarter ellipse shape) having a curve expressed by x²/100²+y²/40²=1. Further, in order to uniformly apply stress, if is usually preferable that a plate having a thickness of 1 mm is produced from the material used in the optical film A and used as a test piece. When the optical film A is a film of a multilayer structure having two or more layers made of different materials, a plate having a thickness of 1 mm is produced in a manner such that a thickness ratio of each of the layers in the optical film A and a thickness ratio of layers made of the respective materials in the plate having a thickness of 1 mm are made equal to each other. Specifically, a craze is caused by distortion generated in the test piece along a curvature of the ellipse of the jig, and thus it is possible to evaluate what degree of the stress is required to cause the craze by measuring the position an which the craze is caused.

The critical stress of the layered body C is measured by fixing a layered body sample as a film piece of the layered body C along the jig shown in FIG. 1 (cross-sectional view) and observing a state of the occurrence of a craze. The layered body sample is fixed to the jig in a manner such that a surface thereof on the optical film A side is brought into contact with the jig. Further, in order to uniformly apply stress to the optical film A, it is usually preferable that a plate having a thickness of 1 mm is produced from the material used in the optical film A and used in place of the optical film A to prepare the layered body sample. In this case, like the layered body C, the layered body sample is produced by forming the adhesive layer B and an optional layer on the plate. Specifically, a craze is caused by distortion generated in the optical film A of the layered body sample along a curvature of the ellipse of the jig, and thus it is possible to evaluate what degree of the stress is required to cause the craze by measuring the position at which the craze is caused.

Further, an optional layer may be provided between the optical film A and the adhesive layer B if necessary. Examples of the optional layer may include a hard coat layer, an index matching layer, an antistatic layer, and a conductive layer. As a material used for forming the hard coat layer, a material that shows a hardness of “HB” or higher in a pencil hardness test defined in JIS K5700 is suitable. Examples of such a material may include: organic materials for forming the hard coat layer such as organic silicone-based, melamine-based, epoxy-based, (meth)acrylate-based, and polyfunctional (meth)acrylic-based compounds; and inorganic materials for forming the hard coat layer such as silicon dioxide. Of these, the (meth)acrylate-based and the polyfunctional (meth)acrylic-based compounds are preferably used as the material for forming the hard coat layer from the viewpoint of their favorable adhesive strength and high productivity.

Examples of the (meth)acrylate-based material for forming the hard coat layer may include (meth)acrylates having one polymerizable unsaturated group per molecule, (meth)acrylates having two polymerizable unsaturated groups per molecule, (meth)acrylates having three or more polymerizable unsaturated groups per molecule, and (meth)acrylate oligomers having three or more polymerizable unsaturated groups per molecule. The (meth)acrylate-based material for forming the hard coat layer may be solely used alone, and two or more types thereof may also be used.

The forming method of the hard coat layer is not particularly limited. The hard coat layer may be formed by, for example, applying a coating liquid of the material for forming the hard coat layer onto the optical film A, removing the solvent by drying, and then crosslinking and curing the dried product by ultraviolet rays, electron beams, or the like. As the method for applying the coating liquid, publicly known methods, such as a dipping method, a spray method, a slide coating method, a bar coating method, a roll coater method, a die coater method, a gravure coater method, or a screen printing method, may be used. Further, the drying of the coating liquid may be performed, for example, under an atmosphere of the air, nitrogen, or the like. Further, the hard coat layer may be formed, for example, by applying a silicone-based, melamine-based, or epoxy-based hard coat layer material onto the optical film A and subjecting the coating film to heat curing. The film thickness of the coating film tends to become uneven during drying. Thus, during drying, it is preferable to adjust and control air intake and exhaust to avoid deterioration in the appearance of the coating film so that the coating film can become uniform over the entire surface. When an ultraviolet curable material is used, an irradiation time required for curing the material for forming the hard coat layer by ultraviolet irradiation after the application is usually in a range of 0.01 seconds to 10 seconds. Further, the amount of irradiation from an energy ray source is usually in a range of 40 mJ/cm² to 1000 mJ/cm² in terms of cumulative exposure to an ultraviolet ray wavelength of 365 nm. Further, the ultraviolet irradiation may be performed, for example, in an inert gas such as nitrogen and argon, and may also be performed in the air.

When the hard coat layer is provided, the optical film A may be subjected to a surface treatment for the purpose of increasing the adhesiveness to the hard coat layer. Examples of the surface treatment may include a plasma treatment, a corona treatment, an alkali treatment, and a coating treatment. Further, the coating liquid of the material for forming the hard coat layer may be applied immediately after the corona treatment or after eliminating electrostatic charge. For a better appearance of the hard coat layer, however, the coating liquid is preferably applied after eliminating electrostatic charge.

The average thickness of the hard coat layer is usually 0.5 μm or more and 30 μm or less, and preferably 2 μm or more and 15 μm or less. If the thickness of the hard coat layer is greater than this range, there is a possibility of reducing visibility, while if it is smaller than this range, there is a possibility of having poor abrasion resistance. The haze of the hard coat layer is usually 0.5% or less, and preferably 0.3% or less.

The material for forming the hard coat layer may contain, for example, organic particles, inorganic particles, a photosensitizer, a polymerization inhibitor, a polymerization initiation aid, a leveling agent, a wettability improving agent, a surfactant, a plasticizer, an ultraviolet absorbing agent, an antioxidant, an antistatic agent, a silane coupling agent, or the like.

### Polarizing Plate

The layered body C may be bonded to a polarizer to product a polarizing plate. For example, the layered body C on the adhesive layer B side may be bonded to a polarizer to product a polarizing plate as shown in FIG. 2. Alternatively, the layered body C on the opposite side to the adhesive layer B may be provided with another adhesive layer and bonded to a polarizer to produce a polarizing plate. The optical film A can function as a protective film for polarizing plate. Examples of the polarizer may include, but is not particularly limited to: a product obtained by allowing a hydrophilic polymer film such as a polyvinyl alcohol film and a partially saponified ethylene vinyl acetate film to adsorb a dichroic substance such as iodine and a dichroic dye and uniaxially stretching the treated film; a product obtained by uniaxially stretching the hydrophilic polymer film and allowing the stretched film to adsorb the dichroic substance; and a polyene-based oriented film such as a dehydrated product of a polyvinyl alcohol and a dehydrochlorinated product of a polyvinyl chloride. Other examples of the polarizer may include a polarizer having a function of separating polarized light into reflected light and transmitted light, such as a grid polarizer and a multi-layer polarizer.

### Liquid Crystal Display Device

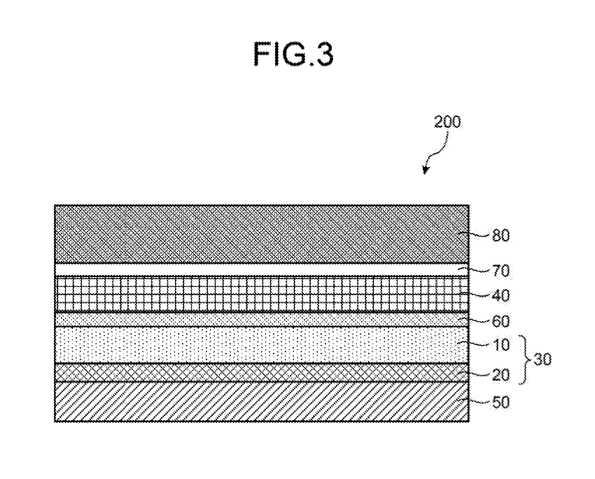

The polarizing plate may be bonded to a liquid crystal panel and a cover glass to product a liquid crystal display device as shown by an example in FIG. 3. FIG. 3 shows a configuration example of a liquid crystal display device 200 in which a cover glass 50 is attached to the layered body on the adhesive layer B side, while the layered body on the opposite side to the adhesive layer B is bonded to a polarizer 40 through another adhesive layer 60, and then a liquid crystal panel 80 is further bonded thereto.

### EXAMPLES

Next, the present invention will be described further in detail by way of Examples. However, the present invention is not limited to the following Examples. Tests and evaluations in Examples and Comparative Examples were conducted by the following methods. In the following description, the terms “%” and “part” expressing quantity are based on weight unless otherwise specified. Further, operations described below were performed under conditions of normal temperature and normal pressure unless otherwise specified.

### (Test Methods and Measurement Methods

### Measurement Method of Critical Stress of Layered Body C

The optical film A having a thickness of 1 mm was cut into a size of 10 mm×90 mm to produce a test piece. The adhesive was applied onto the thus obtained test piece in a thickness of 100 μm to product a layered body sample. The layered body sample was fixed to a jig shown in FIG. 1 (cross-sectional view) within 1 minute after production of the layered body sample. The cross section of the jig shown in FIG. 1 had a shape of a quarter-cut ellipse (one-quarter ellipse shaped having a curve expressed by x²/100²+y²/40²=1.Further, the layered body sample was fixed to the jig in a manner such that a surface thereof on the optical film A side was brought into contact with the jig. The layered body sample was left for 1 hour at 25° C. in a state of being fixed to the jig in this manner and then a distance L (cm) on the curved surface between a position at which a craze was generated and a starting point a of the elliptic jig was measured. The value of L and the thickness of the test piece t (cm) were used to calculate distortion E in accordance with the formula 2. This distortion E was multiplied by a bending elastic modulus of the optical film A to obtain critical stress. The bending elastic modulus of the alicyclic structure-containing polymer (manufactured by ZEON Corporation, glass transition temperature of 123° C.) used in Reference Example 1 described below was 2.2'10⁴ kgf/cm². Further, the bending elastic modulus of the mixture of the alicyclic structure-containing polymer (manufactured by ZEON Corporation, glass transition temperature of 123° C.) and the benzotriazole-based ultraviolet absorbing agent, used in Reference Example 2 described below, was 1.95×10⁴ kgf/cm².

E=0.02×(1−0.0084×L²)^{-3/2}×t (formula 2)

### Measurement Method of Critical Stress of Optical Film A

In place of the layered body sample, the test sample of the optical film A was used without applying the adhesive onto the test piece of the optical film A. The optical film A was measured for critical stress in the same manner as previously described in [Measurement method of critical stress of layered body C] except for the above-mentioned matter.

### Reference Example 1

### Production of Optical Film 1

Pellets of an alicyclic structure-containing polymer (manufactured, by ZEON Corporation, glass transition temperature of 123° C.) were dried for 5 hours at 100° C. The pellets were supplied to an extruder and subjected to injection molding under a condition of 260° C. to obtain an optical film 1 having a thickness of 1 mm. The optical film 1 thus obtained was measured for critical stress by the measurement method described above.

### Reference Example 2

### Production of Optical Film 2

100 parts of a dried alicyclic structure-containing polymer (manufactured by ZEON Corporation, glass transition temperature of 123° C.) and 5.5 parts of a benzotriazole-based ultraviolet absorbing agent (“LA-31”, manufactured by ADEKA Corp.) were mixed by a twin-screw extruder to obtain a mixture. Subsequently, the mixture was charged to a hopper connected to an extruder and supplied to a single screw extruder to produce pellets by melt extrusion. The pellets were formed into a film, in the same manner as in Reference Example 1 to obtain an optical film 2 having a thickness of 1 mm. The optical film 2 was measured for critical stress by the measurement method described above.

### Example 1

### Production of Adhesive 1

A mixed liquid composed of 50 parts of urethane acrylate, 30 parts of pentaerythritol triacrylate, 10 parts of ethoxylated phenonyl acrylate, 4 parts of 4-acryloylmorpholine, 3 parts of benzyl acrylate, and 3 parts of Irgacure 184 (manufactured by BASF Corp.) was uniformly stirred to product an adhesive 1.

### Production of Layered Body 1

The adhesive 1 was applied onto one side of the optical film 1 by using a bar coater to produce a layered body 1. The layered body 1 thus produced has the optical film 1, and an adhesive layer B with a thickness of 100 μm. The layered body 1 was measured for critical stress by the measurement method described above and the critical stress change ratio thereof with respect to the optical film 1 was calculated. The results were shown in Table 1.

### Example 2

### Production of Layered Body 2

A layered body 2 was produced in the same manner as in Example 1 except that an adhesive 2 (LE-3000 series; manufactured by Hitachi Chemical Co., Ltd.) was used in place of the adhesive 1, and measured for critical stress in the same manner. The critical stress change ratio thereof with respect to the optical film 1 was also calculated and the results were shown in Table 1.

### Example 3

### Production of Layered Body 3

A layered body 3 was produced in the same manner as in Example 1 except that the optical film 1 was changed to the optical film 1, and measured for critical stress in the same manner. The critical stress change ratio thereof with respect to the optical film 3 was also calculated and the results were shown in Table 1.

### Example 4

### Production of Layered Body 4

A layered body 4 was produced in the same manner as in Example 2 except that the optical film 1 was changed to the optical film 2, and measured for critical stress in the same manner. The critical stress change ratio thereof with respect to the optical film 2 was also calculated and the results were shown in Table 1.

### Example 5

### Production of Optical Film 3

An optical film 3 was produced in the same manner as in Reference Example 1 except that the thickness of the optical film was changed to 50 μm.

### Production of Layered Body 5

A layered body 5 was produced in the same manner as in Example 1 except that the optical film 1 was changed to the optical film 3, and measured for critical stress in the same manner. The critical stress change ratio thereof with respect to the optical film 3 was also calculated and the results were shown in Table 1.

### Example 6

### Production of Optical Film 4

An optical film 4 was produced in the same manner as in Reference Example 2 except that the thickness of the optical film was changed to 50 μm.

### Production of Layered Body 6

A layered body 6 was produced in the same manner as in Example 2 except that the optical film 1 was changed to the optical film 4, and measured for critical stress in the same manner. The critical stress change ratio thereof with respect to the optical film 4 was also calculated and the results were shown in Table 1.

### Example 7

### Production of Adhesive 3

A mixed liquid composed of 70 parts of urethane acrylate, 20 parts of pentaerythritol triacrylate, 7 parts of methoxyethyl methacrylate, and 3 parts of Irgacure 184 (manufactured by BASF Corp.) was uniformly stirred to product an adhesive 3.

### Production of Layered Body 7

A layered body 7 was produced in the same manner as in Example 1 except that the adhesive 1 was changed to the adhesive 3, and measured for critical stress in the same manner. The critical stress change ratio thereof with respect to the optical film 1 was also calculated and the results were shown in Table 1.

### Example 8

### Production of Layered Body 8

A layered body 8 was produced in the same manner as in Example 7 except that the optical film 1 was changed to the optical film 3, and measured for critical stress in the same manner. The critical stress change ratio thereof with respect to the optical film 3 was also calculated and the results were shown in Table 1.

### Comparative Example 1

### Production of Adhesive 4

A mixed liquid composed of 50 parts of urethane acrylate, 37 parts of isobornyl acrylate, 10 parts of decyl acrylate, and 3 parts of Irgacure 184 (manufactured by BASF Corp.) was uniformly stirred to produce an adhesive 4.

### Production of Layered Body 9

A layered body 9 was produced in the same manner as in Example 1 except than the adhesive 1 was changed to the adhesive 4, and measured for critical stress in the same manner. The critical stress change ratio thereof with respect to the optical film 1 was also calculated and the results were shown in Table 1.

### Comparative Example 2

### Production of Layered Body 10

A layered body 10 was produced in the same manner as in Comparative Example 1 except that the optical film 1 was changed to the optical film 2, and measured for critical stress in the same manner. The critical stress change ratio thereof with respect to the optical film 2 was also calculated and the results were shown in Table 1.

### Comparative Example 3

### Production of Adhesive 5

A mixed liquid composed of 40 parts of urethane acrylate, 21 parts of pentaerythritol triacrylate, 30 parts of a terpene resin, and 3 parts of Irgacure 184 (manufactured by BASF Corp.) was uniformly stirred to product an adhesive 5.

### Production of Layered Body 11

A layered body 11 was produced in the same manner as in Example 1 except that the adhesive 1 was changed to the adhesive 5, and measured for critical stress in the same manner. The critical stress change ratio thereof with respect to the optical film 1 was also calculated and the results were shown in Table 1.

### Comparative Example 4

### Production of Layered Body 12

A layered body 12 was produced in the same manner as in Comparative Example 1 except that the optical film 1 was changed to the optical film 3, and measured for critical stress in the same manner. The critical stress change ratio thereof with respect to the optical film 3 was also calculated, and the results were shown in Table 1.

### Comparative Example 5

### Production of Layered Body 13

A layered body 11 was produced in the same manner as in Comparative Example 1 except that the optical film 1 was changed to the optical film 4, and measured for critical stress in the same manner. The critical stress change ratio thereof with respect to the optical film 4 was also calculated and the results were shown in Table 1.

### Production of Polarizing Plate

Layered bodies 1 to 13 were each bonded to a polarizer that was produced by doping with iodine and uniaxial stretching, and then irradiated with ultraviolet rays to obtain polarizing plates 1 to 13. The polarizing plates 1 to 13 thus obtained were put in an oven at 90° C. for 2 hours, and then inspected for a crack by visually observing their edge surfaces. The inspected results were summarized in Table 1.

TABLE 1

| | | | Critical | | |
|---|---|---|---|---|---|
| | | | stress of | Critical | |
| | | | layered | stress | Edge surface |
| | Optical | Adhesive | body | change | observation |
| | film | layer | (MPa) | ratio (%) | result |
| Ref. | 1 | — | 17.6 | — | — |
| Ex. 1 | | | | | |
| Ref. | 2 | — | 15.6 | — | — |
| Ex. 2 | | | | | |
| Ex. 1 | 1 | Adhesive 1 | 12.0 | 31.8 | No crack |
| Ex. 2 | 1 | Adhesive 2 | 15.7 | 10.8 | No crack |
| Ex. 3 | 2 | Adhesive 1 | 11.0 | 29.5 | No crack |
| Ex. 4 | 2 | Adhesive 2 | 14.3 | 8.3 | No crack |
| Ex. 5 | 3 | Adhesive 1 | 12.0 | 31.8 | No crack |
| Ex. 6 | 4 | Adhesive 2 | 15.7 | 10.8 | No crack |
| Ex. 7 | 1 | Adhesive 3 | 16.0 | 9.1 | No crack |
| Ex. 8 | 3 | Adhesive 3 | 16.0 | 9.1 | No crack |
| Comp. | 1 | Adhesive 4 | 8.5 | 51.7 | Crack |
| Ex. 1 | | | | | occurred |
| Comp. | 2 | Adhesive 4 | 8.4 | 46.1 | Crack |
| Ex. 2 | | | | | occurred |
| Comp. | 1 | Adhesive 5 | 8.0 | 54.5 | Crack |
| Ex. 3 | | | | | occurred |
| Comp. | 3 | Adhesive 4 | 8.5 | 51.7 | Crack |
| Ex. 4 | | | | | occurred |
| Comp. | 4 | Adhesive 4 | 8.4 | 46.1 | Crack |
| Ex. 5 | | | | | occurred |

### INDUSTRIAL APPLICABILITY

The layered body C including the alicyclic structure-containing polymer of the present invention does not cause a crack or a craze in the optical film A due to influence of the adhesive layer B and is excellent in visibility.

### DESCRIPTION OF NUMERALS

10 optical film A
20 adhesive layer B
30 layered body C
40 polarizer
50 cover glass
60, 70 another adhesive layer
80 liquid crystal panel
100 polarizing plate
200 liquid crystal display device
a starting point for bending a test piece

1. A layered body comprising an optical film A including an alicyclic structure-containing polymer and an adhesive layer B, wherein
a critical stress change ratio thereof calculated by the following formula 1 is 40% or less:
$$( critical stress change ratio ) = \frac{( \begin{matrix}critical stress of optical film A - \\ critical stress of layered body\end{matrix} )}{critical stress of optical film A} \times 100 \qquad ( Formula 1 )$$

2. The layered body according to claim 1, wherein the adhesive layer B contains an ultraviolet-curable resin.

3. The layered body according to claim 1, wherein the adhesive layer B contains a urethane acrylate.

4. The layered body according to claim 1, wherein an amount of a material having a high compatibility with the alicyclic structure-containing polymer in the adhesive layer B is 25% by weight or less.

5. A polarizing plate comprising the layered body according to claim 1 and a polarizer.
